(19) United States
(12) Patent Application Publication
(10) Pub. No.: US 2008/0001898 A1
(43) Pub. Date: Jan. 3, 2008

(54) DATA BUS POWER DOWN FOR LOW POWER LCD SOURCE DRIVER

(75) Inventor: Yu-Jui Chang, Tainan (TW)

Correspondence Address: BAKER & MCKENZIE LLP;PATENT DEPARTMENT, 2001 ROSS AVENUE, SUITE 2300, DALLAS, TX, 75201, US

(73) Assignee: HIMAX TECHNOLOGIES, INC., Tainan (TW)

(21) Appl. No.: 11/428,141

(22) Filed: Jun. 30, 2006

(51) Int. Cl. G09G 3/36

(52) U.S. Cl. 345/100

(57) ABSTRACT

The invention provides solutions to solve the power consumption of the image data buses of an LCD source driver. With a bus buffer provided in one embodiment of the invention, a first image data buses are divided into several groups. Each group of image data buses is dispatched by the bus buffer. It is possible in one embodiment of the invention that some groups are active when the others are passive. Therefore, unnecessary power consumption is cut off. Despite the power saved by the management of the bus buffer, the parasitic capacitance of each group of image data buses is much smaller than that of the image data buses in the prior art. Moreover, the management of the bus buffer can depend upon the layout patterns or the layout locations of circuit components so that the driving strength of the bus buffer may be modified according to the layout pattern or the layout locations.

### FIELD OF THE INVENTION

The present invention generally relates to a drive circuit device for a display device such as a liquid crystal display device, and more particularly, certain embodiments of the invention relate to a drive circuit device that reduces power consumption.

### BACKGROUND OF THE INVENTION

As liquid crystal display devices continue to advance at an aggressive pace to replace traditional CRT display devices, the improvement of drive circuit devices are also accelerated in conjunction with the growth of the liquid crystal display devices. A liquid crystal display device can be an active-matrix type which has a plurality of active elements arranged on a flat substrate, e.g., flat glass, in a matrix configuration. Unlike a conventional passive-matrix type of liquid crystal device on which each pixel of the panel is driven by a plurality of conductive wires in columns and a plurality of conductive wires in rows, an active-matrix type uses a tiny active element, like a TFT (Thin film transistor) to direct flowing current and to apply control voltages. It is common to those skilled in the art that a liquid crystal display device employs a plurality of source driver ICs and a plurality of gate driver ICs for activating the display of each basic display element on the flat panel, either switched ON or OFF, such that light generated from a backlight CCFI, (Cathode Cold Fluorescent Light) tube can pass through specified basic display elements while being switched ON, and blocked while being switched OFF.

Normally, the purpose of a gate driver is to provide a series of scanning signals for each row of pixels. According to a scan frequency of a liquid crystal display device, i.e. 60 Hz, images displayed on a screen thereof repeat being refreshed sixty times per second. Human eyes are not able to notice such changes because of the persistence of vision. In a line sequential driving system, only a scanning signal of one row is active in a specified period of time. For example, a first row of pixels is displayed according to image data supplied and activation of a first scanning signal while other scanning signals are passive. Then, a second row of pixels is displayed according to the image data supplied and activation of the second scanning signal while other scanning signals, including the first one, are passive, and so forth.

The image data is supplied by source driver ICs. The source driver ICs are named because outputs of the source driver ICs are sent into the source terminals of the tiny active elements. Each tiny active element comprises a TFT which is a transistor, familiar to those skilled in the art, comprising a source terminal, a drain terminal and a gate terminal. Current can pass the source terminal, through the body of the transistor and be outputted to the drain terminal when the gate terminal, controlled by the output of the gate driver mentioned above, contains an active voltage level. Usually, gamma voltages are provided to assist the source driver ICs for supplying a precise voltage level to twist the liquid crystal molecules of a pixel. With the help of the gamma voltages, an image with complex colors can be shown on a flat display panel.

Therefore, it is easy to understand that there is a huge amount of image data supplied from the source driver ICs into the display panel. Additionally, from time to time the image data increases further when a plurality of moving pictures is demonstrated within a short period of time or a high resolution image is illustrated on a large screen. In actuality, the burden of activating a display panel is given mostly to the source driver ICs. Thus, to reduce the power consumption of the whole liquid crystal display device, it is normal to focus on diminishing the power consumption of the source driver ICs.

As liquid crystal display panels are widely used as monitor screens for computers, they are also integrated into lots of mobile devices, e.g., mobile phones or notebook computers on which the power lasting plays an important role. Without long lasting power, the acceptance of mobile devices is decreased and the convenience of mobile devices is not accomplished. Hence, the power consumption of source driver ICs constitutes a problem as liquid crystal display panels continue to increase the resolution thereof and are embedded into mobile devices.

In U.S. Pat. Publication Nos. US2003/0048249 to Sekido et al. entitled “Drive circuit device for display device, and display device using the same,” a drive circuit device for a display device which drives a plurality of source bus lines provided on a display panel comprises a driver unit used to sequentially fetch data signals and generate drive signals for the source bus lines in accordance to the fetched data signals, a gate unit, after elapse of a specified time from the reception of the driver unit and a timing when a rear-stage drive circuit device starts receiving, starts outputting a propagation signal including a clock signal, data signal and control signals to the rear-stage drive circuit device. This disclosure of which is herein incorporated by reference. Although the power consumption of each source driver ICs is saved according to the disclosure, the power consumption of the source driver ICs is still not reduced. The data buses inside the source driver ICs consume most of power.

In U.S. Pat. No. 6,008,801 to Jeong entitled “TFT LCD source driver,” a source driver circuit is disclosed to reduce the power consumption by employing a first latch for latching a plurality of digital video signals, a second latch for outputting non-inverted and inverted digital video signals, a first multiplexer selecting a group of non-inverted or inverted digital video signals according to an odd polarity signal and an even polarity signal, a second multiplexer selecting digital video signals according to a dot inversion control signal and an output buffer comprising one or two voltage adders. This disclosure of which is herein incorporated by reference. In this disclosure, the source driver uses only a low voltage D/A converter. Although this disclosure reduces the power consumption of the source driver ICs by utilizing at least one voltage adder such as to save one D/A converter, it does not describe how to reduce the power consumption generated on the data bus of the digital video signals.

In U.S. Pat. No. 6,747,626 to Chiang entitled “Dual mode thin film transistor liquid crystal display source driver circuit,” a source driver is able to provide several different operating modes for the driver to lower the power consumption of a TFT-LCD module when still providing a wide analog voltage range to the liquid crystal display elements. This disclosure of which is herein incorporated by reference. An output cell is provided, in the disclosure, for supplying voltages at outputs of the driver circuit when other components including internal resistive, digital to analog converters, decoder/output voltage drivers and output buffer amplifiers are powered down. Although extra output cells and latch circuits are applied in the disclosure, it does not describe a reduction of the power consumption on the data bus where lots of digital video signals are applied from external apparatus, e.g., computers.

As mentioned before, the source driver ICs are burdened with most of the power consumption for displaying images on liquid crystal display panels due to line sequential driving systems that are utilized in most of modern LCD flat panels. The busy data transmission on the video data bus consumes a large portion of power.

### SUMMARY OF THE INVENTION

One aspect of the present invention is to provide a solution to reduce the data bus power consumption of source driver ICs. According to one embodiment of the invention, data buses for transmitting image data of the source driver circuit are divided into several segments controlled by at least one bus buffer. Thus, each segment of image data buses is shorter than the original image data buses. Each segment of image data buses has a smaller parasitic capacitance than in the prior art. The invention provides a source driver circuit comprising a plurality of shift registers having multiple outputs; a line buffer receiving a plurality of image buses and the outputs from the shift registers, and having multiple channel units and first multiple outputs; a D/A converter converting the outputs from the line buffer and having second multiple outputs; a buffer using the second outputs from the D/A converter as reference and generating driving current, and wherein the line buffer contains at least one bus buffer receiving and dispatching the image data buses to channel units. Moreover, the image data buses might contain primary color information including red, green and blue. The bus buffer may comprise at least one multiplexer or at least one tri-state buffer.

In one aspect of the invention, an embodiment of the invention is provided that a source driver circuit comprising at least one bus buffer receiving a first plurality of image data buses; a second plurality of image data buses and a third plurality of image data buses coupled with the bus buffer; a plurality of channel units record image data from the second plurality of image data buses or the third plurality of image data buses; and a plurality of shift registers generating timing signals coupled with the channel units. Additionally, the source driver further comprises a control circuit outputting at least one enable signal to the bus buffer according to the timing signals.

In another aspect of the invention, an embodiment of the invention is provided that a source driver circuit comprising a plurality of shift registers having first multiple outputs; a line buffer receiving a first plurality of image data buses and the first outputs from the shift registers, and having multiple channel units and second multiple outputs; a D/A converter converting the second outputs from the line buffer and having third multiple outputs; a buffer using the third outputs from the D/A converter as reference and generating driving current; wherein the line buffer contains at least one bus buffer receiving and dispatching the first image data buses to channel units; and wherein the bus buffer dispatches the first image data buses into a second plurality of image data buses and a third plurality of image data buses.

### BRIEF DESCRIPTION OF THE DRAWINGS

Various objects and advantages of the present invention will be more readily understood from the following detailed description when read in conjunction with the appended drawing, in which:

FIG. 1 shows a circuit architecture of a source driver IC according to the invention;

FIG. 2 illustrates a line buffer and a 128-bit bi-directional shift register of a source driver 1C in the prior art;

FIG. 3 illustrates a line buffer and a 128-bit bi-directional shift register of a source driver 1C according to one embodiment of the present invention;

FIG. 4 is a diagram illustrating shifting signals from the bi-directional shift registers and control signals to a bus buffer according to the invention; and

FIG. 5 is another embodiment of the invention utilizing a control circuit to dispatch data signals according to the invention.

### DESCRIPTION OF EMBODIMENTS OF THE INVENTION

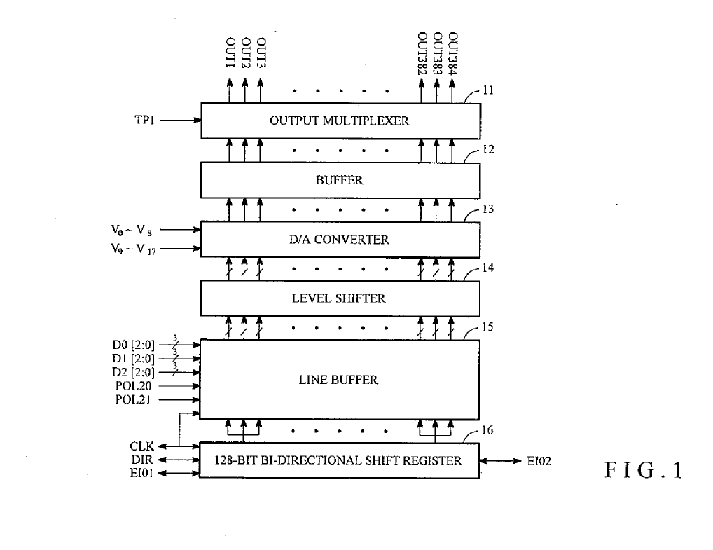

In FIG. 1, the architecture of a source driver IC according to the present invention is shown. A source driver with 384 channels according to an embodiment of the invention comprises a 128-bit bi-directional shift register 16, a line buffer circuit 15, a level shifter circuit 14, a D/A converter circuit 13, a buffer circuit 12 and an output multiplexer circuit 11. In order to receive image data from other circuit components, a clock signal CLK is sent into the 128-bit bi-directional shift register 16 of the source driver. When the image data contains color information, more complicated signals like D0[2:0], D1[2:0] and D2[2:0] are inputted into the line buffer circuit 15 of the source driver. Here, the D0, D1 and D2 according to the embodiment of the invention represent the color information of red, green and blue, each color using three bits to decode the data. As known to those skilled in the art, each of the color signals D0, D1 and D2 might include not only three bits of image data, but six bits of image data for illustrating an image with more complex colorful pixels supporting the display of colorful images on a monitor screen. Moreover, a multicolored monitor screen may show many gray levels of colors demonstrated thereof. A plurality of gamma voltages V0˜V8, V9˜V17 are sent from other circuit component, e.g., gamma voltage circuit, into the D/A converter circuit 13 of the source driver.

The 128-bit bi-directional shift register 16 receives the clock signal CLK and timing signal from an IO port EIO 1 or an IO port EIO 2 depending upon a directional signal DIR. The timing signal can be transmitted from the IO port EIO 1 and outputted from the IO port EIO 2 to a next source driver IC. The timing signal can also be transmitted from the IO port EIO 2 and outputted from the IO port EIO 1 to a next source driver IC. Usually, a TFT flat panel utilizes a plurality of source driver ICs which are arranged in series or connected in cascade. The triggering timing signal is inputted from one side or the other side of the source drivers in cascade. In the embodiment of the invention, one hundred and twenty eight outputs are sent out from the 128-bit bidirectional shift register 16 to the line buffer 15 for controlling the latching operation of the color signals D0, D1 and D2. In one embodiment of the invention, the 128-bit bidirectional shift register 16 contains a plurality of bidirectional shift registers. A 128-bit unidirectional shift register can also be employed in a source driver such that only one propagation direction of timing signals is permissible for those skilled in the art without departing the scope of the invention. Despite the 128-bit bidirectional shift register 16 as an example in one embodiment, other registers might be used in another embodiment of the invention, as well, the specific number of 128-bit bi-directional shift registers 16 in FIG. 1 is only illustrative and not used to limit the scope of the invention.

The line buffer 15 receives a plurality of timing signals sequentially in a time scale from the 128-bit bidirectional shift register 16. Normally, a line buffer 15 comprises a plurality of registers, e.g., latches or flip-flops, able to keep data temporarily. According to one embodiment of the invention, color signals D0, D1 and D2 are from other circuit components. For example, the color signals may be transmitted from a computer, a timing controller or a graphic card. In one embodiment of the invention, the color signals D0, D1 and D2 form a data bus comprising a plurality of data signals connected to multiple registers of the line buffer 15 such that each of the registers of the line buffer 15 grasps necessary color signals from the same data bus comprising color signals D0, D1 and D2, to share data buses is a technique for saving layout area on an integrated circuit chip of which the area is the main cost. It acquires necessary timing signals from the 128-bit bi-directional shift register 16 to manage each register for sharing the data bus in an appropriate period of time. In a color source driver, one pixel of the colorful panel comprises at least a red, a green and a blue sub-pixel. The line buffer 15 according to the embodiment of invention utilizes a timing signal for three registers to latch one bus of D0, D1 and D2, respectively, so that one hundred and twenty eight timing signals control three hundred and eighty tour monochromatic pixels or one hundred and twenty eight chromatic pixels of the display panel. In FIG. 1, a clock signal CLK is also necessary for the line buffer 15 to trigger the appropriate latching events. In addition, few polarity signals POL20, POL21 are employed because liquid crystal display panels often use inversion methods to avoid damage of pixels and DC (direct current) voltage accumulation. The inversion method usually used is line inversion, dot inversion or N-line inversion method. Other inversion methods are also possible as long as the permanent twist force and DC voltage accumulation are controlled. Then, a plurality of outputs containing information of color and polarity of pixels are further outputted for next signal processing stage.

The level shifter 14 is used to transfer the digital data which is outputted from the line buffer 15, to other analog voltage levels which are able to control and communicate with the analog world, e.g., the liquid crystal display panel. Normally, the level shifter 14 comprises a plurality of level shifter components each of which might contain an inverter. When the input of the level shifter component is low, the output of the level shifter component is connected to ground. On the contrary, the output of the level shifter component is connected to a supplied voltage much higher or much lower than the normal power for digital logic circuits when the input of the level shifter component is a digital logic high. For those skilled in the art, it is easy to find several circuit configurations of level shifters. More detailed descriptions are ignored here.

The D/A converter 13 actually receives the digital data from the line buffer 15 containing the color and polarity information of image data but in an analog form with the transformation of the level shifter 14. The color information of the digital data from the line buffer 15 further contains gray levels of each pixel. The indication of gray levels helps the D/A converter 13 to select one of a plurality of gamma voltages V0˜V17 so that each pixel can display a color with a gray level. It is important that a colorful image shown on the screen contains three primary colors and a plurality of gray levels. Each selected gamma voltage is further sent out to a next stage such that precise color information and strong driving force are provided by the source driver to the liquid crystal display panel.

The buffer 12 is an interface to receive the selected gamma voltage of each pixel and provide enough current driving ability, according to the received gamma voltage, to the liquid crystal display elements, e.g., liquid crystal display pixels. Only by providing sufficient current to the pixels can the display panel show correct color information in time without creating distortion or a flicker. A plurality of source followers constitutes the buffer 12. A source follower can be implemented by a single transistor. Usually, a plurality of unit gain operational amplifiers is employed in the buffer 12 such that the outputted voltage can reach the original inputted gamma voltage without deduction of voltage.

The output multiplexer 11 is usually synchronized by a signal TP1 in a line sequential driving system. In a line sequential driving system, a line of the driving system comprising a plurality of pixels in row is not changed until the accomplishment of a previous scanning signal. It is to say that every pixels arranged in a horizontal line should be ready before the trigger of a signal TP1. There are also other advantages to using the output multiplexer 11. When the display controller is powered down into a low power mode, the output multiplexer 11 might be switched to another regulator supplying the panel with current to still display the image shown on the screen if the image continues to be shown under low power mode. In this way, other components like line buffer 15 and level shifter 14 can be entered into low power mode with little power consumption. Finally, a plurality of outputs, e.g., OUT 1˜384, is sent out from the output multiplexer 11 for displaying pixels of the liquid crystal display panel.

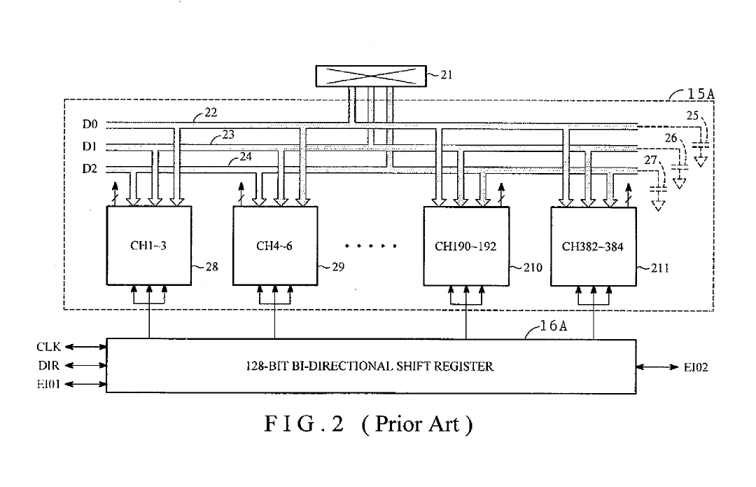

For better illustrating the advantages and benefits of the present invention, a description of an example of a line buffer 15 in the prior art is described here as in FIG. 2 for comparison. A 128 bidirectional shift register 16A of a source driver IC provides one hundred and twenty eight outputs according to a clock signal CLK, an IO port EIO 1 and a direction control signal DIR. The 128 bi-directional shift register 16A comprises another IO port EIO 2 when cascading multiple source driver ICs in serial is needed. A more detailed drawing of a line buffer 15A in the prior art is drawn here. The IO port EIO 1 receives timing signals and then outputs pulses of latch timing signals for the channel units 28˜29, 210˜211 of the line buffer 15A. Here, the channel unit 28 comprises three channels 1˜3 and latches image data on the data buses D0 22, D1 23 and D2 24 according to one timing signal from the 128 bi-directional shift register 16A although this one timing signal controls three channels constituting the channel unit 28. The other channel unit 29, 210, 211 are similar to the channel unit 28. Only four channel units 28, 29, 210, 211 are shown in detail in the figure. However, other channel units not shown can be recognized as similar to those four channel units 28, 29, 210, 211. An input pad circuit 21 of the source driver IC accepts color signals via data bus D0 22, data bus D1 23 and data bus D2 24. Each of the data buses is shared by all the channel units. Therefore, it creates a problem of power consumption.

Each data bus contains a metal line forming a capacitive load corresponding to the substrate of the silicon chip or ground. A lumped capacitor 25 drawn and coupled with the data bus D0 22 shows the total capacitive effect of all metal lines of the data bus D0 22. Another capacitor 26 drawn and coupled with the data bus D1 23 shows the total capacitive effect of all metal lines of the data bus D1 23. Still another capacitor 27 drawn and coupled with the data bus D2 24 shows the total capacitive effect of all metal lines of the data bus D2 24. For those skilled in the art, it is natural that the power consumption of a capacitor is described as the following equation:

$$p = \frac{1}{2} {fcv}^{2}$$

### Where p represents the power consumption of signals on the metal lines; f is the frequency of signals; c is the capacitive loading on the metal lines; and v is the supplied voltage of signals applied on the metal lines.

Although reducing the supplied voltage makes significant effect on the power consumption, it is not easy to achieve the goal without the advancement of semiconductor technology. Slowing down the operating frequency can also lower the power consumed on the metal lines. However, this might downgrade the performance of functions.

Despite the parasitic capacitance caused by long metal lines, parasitic resistance is also another concern affecting the performance of the data transmission of the data buses. It can be thought of as a plurality of small resistors connected in series such that the voltage level of input signals drops along the metal lines. It is possible that the voltage level drops under the threshold voltage of circuit devices that the information embedded in the transmission disappears or drops to a level sensitive to noises on a silicon chip and becomes inaccurate.

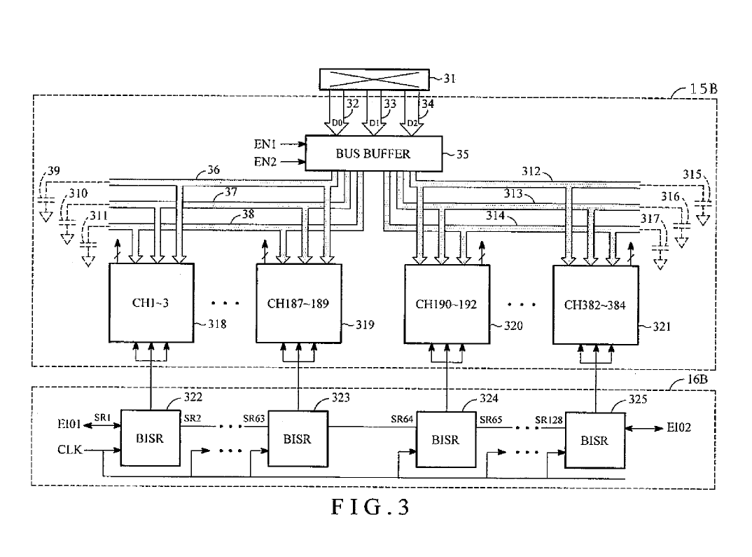

Therefore, one embodiment proposed by the present invention is disclosed in FIG. 3. The embodiment of the invention is a source driver comprising a 128 bi-directional shift register 16B, a plurality of channel units 318˜321, a plurality of data buses 36˜38, 312˜314 and a bus buffer 35. The source driver further comprises an input pad circuit 31 accepting color signals from an external source e.g., a computer interface, a timing controller or a graphic card, and transporting the signals into the source driver via a data bus D0 32, a data bus D1 33 and a data bus D2 34. With the dispatching of the bus buffer 35, each group of channel units receives image data from at least one specific data bus depending upon the dispatching of the bus buffer 35. According to the embodiment of the invention, the power consumed by the toggles of signals on the data bus made of metal lines is significantly reduced.

The 128 bidirectional shift register 16B comprises a plurality of bidirectional shift registers 322˜325 each triggered by a clock signal CLK. A timing signal can be inputted from either an IO port EIO 1(SR1) or another IO port EIO 2. In the embodiment of the invention, bi-directional shift registers are used only for demonstrating the illustration of the invention. For those skilled in the art, several modifications and changes can be made within the scope of the invention. For example, the bidirectional shift register can be replaced by a unidirectional shift register if the specification of the source driver is not required to be bi-directional. The bi-directional shift registers can comprise flip-flops or latches, as well. After receiving the timing signal, the bidirectional shift register 322 passes timing signal SR2 to the next bidirectional shift register (not shown) in cascade. In FIG. 3, a bidirectional shift register 323 and a bi-directional shift register 324 which receive timing signal SR63 and SR64 respectively are drawn in detail only for explaining the embodiment of the invention. Other possibilities by grouping arbitrary groups of channel units are possible, too. Here, the bidirectional shift register 324 would output timing signal SR65 for the next bidirectional shift register (not shown), and the bi-directional shift register 325 would receive the timing signal SR128 and drive out signals to the IO port EIO 2 if there were another source driver IC in series.

The channel units 318˜321, data buses D0 32, D1 33, D2 34, bus buffer 35 and a plurality of data buses 36˜38, 312˜314 constitute a line buffer 15B having the same function as the line buffer 15 in FIG. 1. The channel units 318˜321 record their own image data from the data buses 36˜38, 312˜314 upon being triggered by the sequential outputs from the bi-directional shift registers. The channel units 318˜321 further output the recorded image data to the level shifter 14 mentioned in FIG. 1. The bus buffer 35 of the embodiment of the invention groups the original image data buses D0 32, D1 33, D2 34 into one group of image data buses 36˜38 and another group of image data buses 312˜314. The group of image data buses 36˜38 are dispatched to provide data transmission to the channel units 318, 319. Here, the channel units 318, 319 are only illustrative. Actually, the group of image data buses 36˜38 can be dispatched to channel units including one hundred and eighty nine channels. The other group of image data buses 312˜314 are dispatched to provide data transmission to the channel units 320, 321. Here, the channel units 320, 321 are only illustrative. Actually, the group of image data buses 312˜314 can be dispatched to channel units including one hundred and eighty nine channels.

The management of the dispatching of the bus buffer 35 is controlled by two enable signals EN1, EN2. The waveforms of the enable signals and the timing signals of the bi-directional shift registers will be described later. When the enable signal EN1 is active, the image data on the data buses D0˜D2 32˜34 are dispatched to the image data buses 36˜38. In the meanwhile, the image data buses 312˜314 are forced to be passive. On the contrary, when the enable signal EN2 is active, the image data on the data buses D0˜D2 32˜34 are dispatched to the image data buses 312˜314. In the meanwhile, the image data buses 36˜38 are forced to be passive. Capacitors 39, 310, 311 represents the parasitic capacitance created by the metal lines of data buses 36˜38 respectively, and capacitors 315˜317 represents the parasitic capacitance created by the metal lines of data buses 312˜313 respectively. Since the data buses are divided into two groups, the length of the metal lines are also divided into segments each of which comprises about half the capacitance created by each of the parasitic capacitors 25˜27 in FIG. 2 which is an example in the prior art. According to the equation of power calculation, the power consumption is reduced to about half. With the bus buffer, the voltage level under transmission is maintained without reduction due to the parasitic resistance of the metal lines so that there is not much voltage drop throughout the bus line. Also, immunity against noise is achieved. Moreover, the reduction of capacitive loading of the channel units is also possible. Each channel unit contains a plurality of channels comprising logic circuits. Since the number of channels is enormous, the gate capacitance of the logic circuits of the channels can not be ignored, too. Hence the power consumption on the data buses is further lowered again.

The bus buffer 35 can be implemented by a multiplexer or tri-state buffer whose select signals are connected to the enable signals EN1, EN2. The bus buffer 35 can be implemented by simple logic circuits, e.g., NAND logic circuits, NOR circuits and inverters, too. Moreover, the enable signals EN1, EN2 are generated according to the timing signals SR63 and SR64 informing the bus buffer 35 to activate the specific group of data buses. The enable signals EN1, EN2 can also be generated by a counter which counts the timing according to the clock signal CLK and at least one predetermined value. Furthermore, the embodiment of the invention does not necessarily need both enable signals. Since there are only two groups of data buses, one enable signal is able to control the activation of both data buses. The two enable signals EN1, EN2 here are for illustrative purposes only.

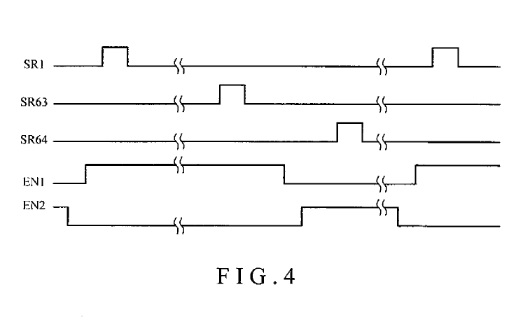

FIG. 4 is a diagram illustrating shifting signals from the bi-directional shift registers and control signals of a bus buffer according to the invention. Only the necessary timing signals SR1, SR63 and SR64, and enable signals EN1 and EN2 are shown here. As mentioned above, the timing signals SR1, SR63, SR64 are sequential signals. Once a timing event is triggered at the IO port EIO 1 (SR1), a series of timing events will be generated between these cascading bi-directional shift registers. The high pulse of timing signal SR63 means that the triggering event is delivered to the sixty third bidirectional shift register. Similarly, the high pulse of timing signal SR64 occurred at a time later than that of the timing signal SR63. The two high pulses of the timing signal SR1 represent a complete cycle for each channel to grasp data from the image data buses. The two high pulses of the timing signal SR1 also means the accomplishment of image data loaded during one of the scan events generated by gate drivers. The unnecessary time scale is omitted in FIG. 4 since no timing event occurs.

The enable signal EN1 goes into a high level covering timing events of the timing signals SR1 and SR63. Of course, the timing events occurred between the events of the timing signals SR1 and SR63 are also covered. Moreover, the enable signal EN2 goes into a high level covering timing events of the timing signals SR64 and SR128 (not shown). The timing events occurred between the events of the timing signals SR64 and SR128 (not shown) are also included. When the enable signal EN1 goes high, only the data buses 36˜38 of the embodiment of the invention shown in FIG. 3 are activated, conversely, when the enable signal EN2 goes high, only the data buses 312˜314 are activated. Thus, the capacitive loading of the chosen data buses are about half of that in the prior art. The capacitive loading of driven channels is also half compared to that in the prior art.

The waveforms shown in FIG. 4 are only for illustration. Several variations and modifications are possible. For example, one enable signal is enough to control two groups of data buses. In one embodiment, a plurality of enable signals could be employed once there was a plurality of groups of data buses. In still another embodiment, the grouping of the data buses may be two groups with unequal number of buses. There are still many options available for grouping the data buses arbitrarily. In yet another embodiment, the grouping of the data buses depends upon the layout pattern on the silicon chip. Moreover, a plurality of bus buffers can be employed such that a complex management of data buses is possible.

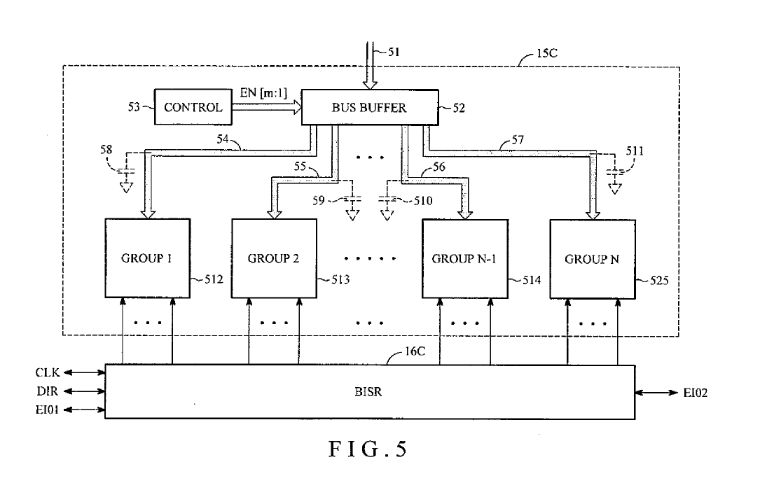

FIG. 5 is another embodiment of the invention utilizing a control circuit to dispatch data signals according to the invention. A source driver with a plurality of channels according to another embodiment of the invention comprises a bus buffer 52 receiving a main image data bus 51 and controlling a plurality of data buses 54˜57, n number of groups of channels 512˜515 where n is an arbitrary integral number, a control circuit 53 outputting m number of enable signals EN[m:1] where m is an arbitrary integral number less than the number n, and a bi-directional shift register 16C outputting a number of outputs equal or less than the number of channels of the source driver. The bus buffer 52, control circuit 53, groups of channels 512˜515 and multiple data buses 54˜57 constitute a line buffer 15C according to one embodiment of the invention. In this embodiment of the present invention, the bidirectional shift register 16C receives a clock signal CLK, a directional control signal DIR, an IO port EIO 1 and another IO port EIO2. The IO ports EIO 1 and EIO 2 can be unidirectional or bidirectional if it is necessary. The number of channels of each group may be different. The grouping can rely on the driving ability of the channels or the architecture of circuits. Additionally, the grouping can depend upon the actual layout patterns or the actual layout locations of the circuits and data buses. Therefore, the parasitic capacitors 58, 59, 510, 511 of the data bus 54, 55, 56, 57 respectively have different capacitance with each other according to the driving ability, circuit architectures, layout patterns or layout locations of the circuit components on the source driver chip. Moreover, the control circuit 53 outputting enable signals EN[m:1] can have inputs from the timing signals generated by the bidirectional shift register 16C for obtaining appropriate timing information or from an embedded counter counting numbers synchronized with the clock signal CLK.

It is to be understood that these embodiments are not meant as limitations of the invention but merely exemplary descriptions of the invention with regard to certain specific embodiments. Indeed, different adaptations may be apparent to those skilled in the art without departing from the scope of the annexed claims. For instance, it is possible to add bus buffers on a specific data bus if it is necessary. Moreover, it is still possible to have a plurality of bus buffers cascaded in series.

What is claimed is:

1. A source driver circuit for driving an LCD panel, comprising:
a plurality of shift registers having a plurality of first outputs;
a line buffer having at least one bus buffer to drive a portion of an image data bus depending on a control signal.

2. The source driver circuit according to claim 1 further comprising:
a D/A converter to convert a plurality of second outputs from the line buffer;
a buffer to generate a driving current;
a plurality of gamma voltages coupled with said D/A converter; and
a level shifter to convert a plurality of said second outputs to corresponding voltage levels wherein said line buffer has multiple channel units coupled with said image data bus for different colors.

3. The source driver circuit according to claim 1, further comprising:
an output multiplexer to synchronize said driving current of said buffer.

4. The source driver circuit according to claim 1, wherein said shift registers are connected in serial and triggered by a clock signal.

5. The source driver circuit according to claim 1, wherein said line buffer receives the outputs from said shift registers sequentially in time scale.

6. The source driver circuit according to claim 2, wherein each of said channel units comprises at least one register being able to keep image data temporarily.

7. The source driver circuit according to claim 1 wherein said image data bus comprises a red data bus, a green data bus and a blue data bus.

8. The source driver circuit according to claim 1 wherein said bus buffer comprises at least one multiplexer.

9. The source driver circuit according to claim 1, wherein said bus buffer comprises at least one tri-state buffer.

10. The source driver circuit according to claim 1, wherein said bus buffer comprises at least one NAND logic circuit and one inverter.

11. The source driver circuit according to claim 1, wherein said bus buffer drives two portions of an image data bus separately.

12. The source driver circuit according to claim 1, wherein said bus buffer selects to drive which portion of an image data bus according to at least one enable signal.

13. The source driver circuit according to claim 12, wherein said enable signal is determined according to at least one timing signal generated by said shift registers.

14. The source driver circuit according to claim 12, wherein said enable signal is determined according to a counter triggered by a clock signal.

15. A source driver circuit or driving an LCD panel, comprising:
at least one bus buffer to drive a portion of an image data bus;
a plurality of channel units to record image data; and
a plurality of shift registers to generate timing signals coupled with said channel units.

16. The source driver circuit according to claim 15, further comprising:
a control circuit outputting at least one enable signal to said bus buffer according to said timing signals.

17. The source driver circuit according to claim 15, further comprising:
a control circuit outputting at least one enable signal to said bus buffer according to a counter triggered by a clock signal.

18. The source driver circuit according to claim 15, wherein said bus buffer drives two portions of an image data bus separately.

19. A source driver circuit for driving an LCD panel, comprising:
a line buffer having at least one bus buffer to drive a portion of an image data bus;
a plurality of channel units to record image data;
a plurality of shift registers to generate timing signals coupled with said channel units; and a D/A converter to convert a plurality of outputs from said line buffer.

20. The source driver circuit according to claim 19, further comprising:
a plurality of gamma voltages coupled with said D/A converter; and
a level shifter converting a plurality of said outputs from said line buffer to corresponding voltage levels.

21. The source driver circuit according to claim 19, further comprising:
an output multiplexer to synchronize driving of said line buffer.

22. The source driver circuit according to claim 19, wherein said line buffer receives the outputs from said shift registers sequentially in time scale.

23. The source driver circuit according to claim 19, wherein each of said channel units comprise at least one register being able to keep image data temporarily.

24. The source driver circuit according to claim 19, wherein said image data bus comprises a red data bus, a green data bus and a blue data bus.

25. The source driver circuit according to claim 19, wherein said bus buffer comprises at least one multiplexer.

26. The source driver circuit according to claim 19, wherein said bus buffer comprises at least one tri-state buffer.

27. The source driver circuit according to claim 19, wherein said bus buffer comprises at least one NAND logic circuit and one inverter.

28. The source driver circuit according to claim 19, further comprising:
a control circuit outputting at least one enable signal to said bus buffer.

29. The source driver circuit according to claim 28, wherein said control circuit is controlled by at least one timing signal generated by said shift registers.

30. The source driver circuit according to claim 28, wherein said control circuit comprises a counter.

31. The source driver circuit according to claim 19, wherein said bus buffer drives two portions of an image data bus separately.
